(19) United States
(12) Patent Application Publication
(10) Pub. No.: US 2024/0102403 A1
(43) Pub. Date: Mar. 28, 2024

(54) PROCESS FOR UTILIZING WASTE HEAT AND CARBON DIOXIDE FROM THE PRODUCTION OF LOW, NEUTRAL, AND/OR NEGATIVE CARBON INTENSITY HYDROGEN FROM ELECTROLYSIS

(71) Applicant: Kraken Technology Holdings, LLC, Houston, TX (US)

(72) Inventors: Christopher Michael MILLER, Richmond, TX (US); Anna Louis BUCKLEY, Houston, TX (US); Byron Gladus BEST, III, Katy, TX (US); Bengt Arne JARLSJO, Houston, TX (US); Daniel Joseph SHAPIRO, Houston, TX (US)

(21) Appl. No.: 18/472,914

(22) Filed: Sep. 22, 2023

Related U.S. Application Data
(63) Continuation-in-part of application No. 18/451,508, filed on Aug. 17, 2023.
Application No. 18/451,508 is a continuation-in-part of application No. 18/471,768, filed on Sep. 21, 2023.
(60) Provisional application No. 63/500,944, filed on May 9, 2023.
(60) Provisional application No. 63/451,940, filed on Mar. 14, 2023.
(60) Provisional application No. 63/482,430, filed on Jan. 31, 2023.
(60) Provisional application No. 63/409,331, filed on Sep. 23, 2022.

(51) Int. Cl. F01K 27/02; C25B 1/04; F01K 25/10; F01K 25/14

(52) U.S. Cl. CPC F01K 27/02; C25B 1/04; F01K 25/103; F01K 25/14

(57) ABSTRACT

A method for providing energy from waste heat from an electrolysis process to one or more commercial or industrial operations is provided. The method includes the steps of converting water to oxygen and a hydrogen product through an electrolysis process, wherein the hydrogen product has a carbon intensity less than about 0.45 kg CO2e/kg H2, and wherein at least some of the required energy for the electrolysis process is provided from a biomass power plant. The method further includes recovering waste heat from the electrolysis process, and then converting at least some of the waste heat to thermal energy for use in the one or more commercial or industrial operations. Examples of commercial and industrial operations includes, without limitation, greenhouses, algae farms, district cooling, and district heating.

### CROSS-REFERENCE TO RELATED APPLICATION

This application claims the benefit of U.S. Prov. App. Nos. 63/500,944 (filed May 9, 2023), 63/451,940 (filed Mar. 14, 2023), 63/482,430 (filed Jan. 31, 2023), and 63/409,331 (filed Sep. 23, 2022); and is a continuation-in-part of U.S. application Ser. No. 18/451,508 (filed Aug. 17, 2023) and Ser. No. 18/471,768 (filed Sep. 21, 2023); each of which is incorporated by reference herein in its entirety.

### BACKGROUND

The present invention relates to a method and process for the beneficial use of waste heat and/or carbon dioxide produced during the production of low, neutral and/or negative carbon intensity hydrogen from electrolysis.

Many industrial applications that generate waste heat use either cooling water or air-cooled heat exchangers to cool process fluids. In these applications, the heat generated by the system is rejected to the atmosphere by evaporative cooling towers or fans. This waste heat could be captured for beneficial use to optimize the heat integration of the facility and/or for external beneficial purposes.

As the global economy drives towards environmental, social, and governance (ESG) solutions for industrial facilities, waste heat will be captured and utilized for beneficial use. ESG solutions will also drive industrial facilities to capture carbon dioxide, which can be repurposed for beneficial use or permanently sequestered.

Low, neutral, and/or negative carbon intensity hydrogen produced through electrolysis of water with biomass energy generates several waste heat streams that can be harnessed and repurposed for beneficial uses including heat integration with industrial processes, including greenhouses.

Greenhouses provide a sheltered, artificial environment to facilitate the growth of plants in a non-ideal climate. Even in temperate climates, greenhouses require artificial heating to maintain temperatures above freezing and provide an optimal temperature for plant growth. Most of the heat is lost from conduction of the heat from the warm greenhouse interior through the greenhouse glazing to the colder exterior. Heat can also be lost from infiltration of cold air through cracks or holes in the exterior of the greenhouse, including doors and ventilation systems. Radiation, the transfer of heat from a warm greenhouse to a colder exterior environment without direct contact, can also lead to greenhouse heat loss.

To overcome heat loss to the environment and maintain an ideal temperature, greenhouses are equipped with central and/or local heating systems. Typically, central heating systems consist of a boiler and a distribution system that supplies thermal energy, as either hot water and/or steam, to the greenhouse. Local heating systems, either vented or unvented unit heaters, transfer heat through the combustion of hydrocarbon gases to provide heating to the greenhouse.

Both the central and local heating systems provide a source of thermal energy for greenhouse heating. According to the present invention, waste heat from a nearby hydrogen production facility and/or the integrated biomass power plant can be utilized to provide thermal energy, in the form of hot water and/or steam, to nearby greenhouses instead of a dedicated central or local heating system to maintain temperatures above freezing and provide an optimal temperature for plant growth. The carbon neutral or carbon negative electricity produced from the biomass power plant for the production of low, neutral, and/or negative carbon intensity hydrogen can also be used to provide power to the greenhouse directly. Carbon neutral or carbon negative electricity can be used to power growth lights, which are designed to stimulate photosynthesis and prolong exposure in the absence of natural sunlight, enhancing plant growth.

Carbon dioxide is also used beneficially to supplement or enrich the CO₂ concentration of the air inside greenhouses. CO₂-enriched greenhouses provide numerous benefits including improved yields, earlier flowering, increased number and size of flowers, increased stem/leaf size and thickness, and reduced number of days to maturation. The saturation point for most plants is reached at concentrations of 1,000-1,200 ppm of CO₂, whereas the saturation point for most seedlings is reached at concentrations of 800-1,000 ppm of CO₂. For comparison purposes, the atmospheric CO₂ concentration is approximately 420 ppm. By supplementing the greenhouse air with captured CO₂, greenhouses can produce better quality and larger quantity of fruits, vegetables, and/or flowers as compared to greenhouses without supplemental CO₂.

Carbon dioxide can also be used beneficially for aquacultural purposes, specifically algae farms to enrich the CO₂ concentration of the sparging air. Depending on the type of algae and/or microalgae, enhanced growth occurs at concentrations of 0.5-2 vol % CO₂. By enriching the sparging air, algae can be produced in larger quantities for use in fertilizers, animal food, food supplements, and/or biofuels. According to the present invention, carbon dioxide can be captured and either utilized in beneficial applications or sequestered in geological formations. In the production of low, neutral, and/or negative carbon intensity hydrogen, captured carbon dioxide from the integrated biomass power plant can be used beneficially, including for use in greenhouses and/or algae farms (e.g. aquaculture).

### SUMMARY OF THE INVENTION

A method for providing energy from waste heat from an electrolysis process to one or more commercial or industrial operations is provided. The method includes the steps of converting water to oxygen and a hydrogen product through an electrolysis process, wherein the hydrogen product has a carbon intensity preferably less than about 0.45 kg CO₂e/kg H₂, more preferably less than 0.0 kg CO₂e/kg H₂. At least some of, and preferably substantially all of the required energy for the electrolysis process is provided from a biomass power plant, wherein the energy produced by the biomass power plant is selected from one or more of: (a) electricity generated from work produced by a Rankine cycle, Brayton cycle, or integrated gasification combine cycle; (b) steam that can be used as process steam in the hydrogen production process; (c) steam that can be used as thermal energy; or (d) steam that can be used to power a mechanical drive. One or more gas streams containing carbon dioxide from the biomass power plant may be processed in a carbon capture unit to reduce CO₂e emissions.

The waste heat is recovered from the electrolysis process, and then at least some of the waste heat is converted to thermal energy for use in the one or more commercial or industrial operations. At least some of the thermal energy may be converted to steam to power a mechanical drive for one or more motors generating shaft torque in the one or more commercial or industrial operations. The thermal energy may also be used to produce hot water or steam for district heating in the one or more commercial or industrial operations. The thermal energy may also be used to produce hot water or steam for an absorption chiller to provide chilling duty for district cooling in the one or more commercial or industrial operations.

The one or more commercial or industrial operations may be one or more greenhouses, wherein the thermal energy is used to heat the one or more greenhouses. Carbon dioxide recovered from the biomass power plant may be used to supplement the CO₂ concentration of the air inside the one or more greenhouses. The one or more commercial or industrial operations may also be one or more algae farms, wherein the thermal energy is used to heat the one or more algae farms. Carbon dioxide recovered from the biomass power plant may be used to enrich the CO₂ concentration of the sparging air in the one or more algae farms. The one or more commercial or industrial operations may be district utilities comprising one or both of district cooling and district heating.

### DESCRIPTION OF FIGURES

The features and advantages of the present invention will be more clearly understood from the following description taken in conjunction with the accompanying drawings in which:

FIG. 1 depicts a process flow diagram in which waste heat from the production of low, neutral, and/or negative carbon intensity hydrogen from electrolysis is used as a source of heat for a greenhouse.

FIG. 2 depicts a process flow diagram in which waste heat from the production of low, neutral and/or negative carbon intensity hydrogen from electrolysis is used as a source of heat for a greenhouse.

FIG. 3 depicts a process flow diagram for the process of FIG. 1, in which the required energy is provided from a traditional, air fired biomass boiler with carbon capture.

FIG. 4 depicts a process flow diagram for the process of FIG. 2, in which the required energy is provided by a biomass boiler with carbon capture and a combined cycle gas turbine with carbon capture.

### DETAILED DESCRIPTION OF THE INVENTION

The present invention relates to a method and process for the beneficial use of waste heat and/or carbon dioxide produced during the production of low, neutral and/or negative carbon intensity hydrogen from electrolysis.

In all embodiments of the present invention described herein, the low, neutral, and/or negative carbon intensity hydrogen from electrolysis is produced according to the teachings of commonly owned U.S. Prov. App. No. 63/451,940 (filed Mar. 14, 2023) and U.S. application Ser. No. 18/471,768 (filed Sep. 21, 2023), each of which is incorporated by reference herein in its entirety. As discussed therein, the energy for the hydrogen production process is provided by the combustion or gasification of various forms of biomass to reduce the carbon intensity of the hydrogen product to preferably less than 0.45 kg CO₂e/kg H₂, and more preferably less than 0.0 kg CO₂e/kg H₂.

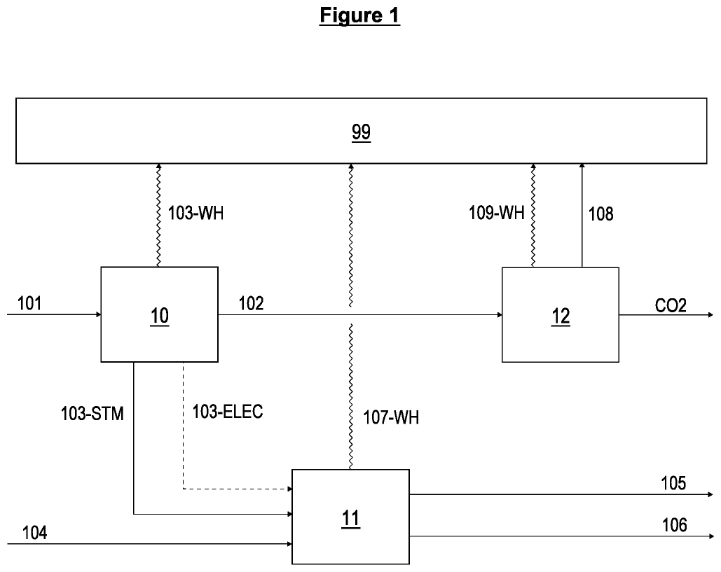

With reference to FIG. 1, a first embodiment of the present invention is shown, in which waste heat from the production of low, neutral and/or negative carbon intensity hydrogen from electrolysis is used as a source of thermal energy to provide heating for one or more greenhouses.

Biomass power plant 10 generates carbon negative energy in the form of electricity 103-ELEC and/or steam 103-STM. The energy produced from biomass power plant 10 is generated by either a Rankine cycle, a Brayton cycle, or an integrated gasification combined cycle (IGCC), which consists of both a Rankine cycle and Brayton cycle.

Where biomass power plant 10 comprises a Rankine cycle, energy is produced from the direct combustion of biomass feedstock 101 in a biomass boiler to generate steam. The generated steam from the biomass power plant can be sent to a Rankine cycle steam turbine to produce electricity 103-ELEC. Furthermore, steam 103-STM can be sent directly to electrolysis unit 11 or can be extracted from the turbine and sent to electrolysis unit 11.

Where biomass power plant 10 comprises a Brayton cycle, biomass feedstock 101 is gasified to create a syngas product that is combusted as a fuel in a Brayton cycle gas turbine to produce electricity 103-ELEC.

Alternatively, biomass power plant 10 can be configured as an IGCC plant in which biomass feedstock 101 is gasified to create a syngas product with or without steam generation. The syngas can be combusted as fuel in a Brayton cycle gas turbine to generate electricity 103-ELEC. Steam 103-STM can also be generated with a heat recovery steam generator (HRSG) on the gas turbine exhaust. 103-STM can be used in a Rankine cycle to generate additional electricity 103-ELEC. Steam 103-STM can also be used as process steam or as thermal energy in electrolysis unit 11. Additional uses of this carbon negative energy (103-ELEC and 103-STM) are discussed below with respect to additional embodiments of the present invention.

In electrolysis unit 11, water 104 is converted to low, neutral, and/or negative carbon intensity hydrogen 105 and oxygen 106 through electrolysis using carbon negative energy in the form of electricity, 103-ELEC, and/or steam, 103-STM, from biomass power plant 10. The carbon negative energy produced from biomass power plant 10 can be combined with higher carbon intensity energy, including grid import power, to achieve a targeted carbon intensity of hydrogen 105. Although not shown, hydrogen product 105 can be utilized to produce low, neutral, and/or negative carbon intensity hydrogen derivatives and/or hydrogen carriers, including but not limited to ammonia.

Carbon dioxide 102 can be captured from the biomass power plant flue gas stream. Carbon dioxide 102 can be compressed in CO₂ compression unit 12 and sent to geologic sequestration or can be used external to the process. Carbon dioxide 108 can also be used to supplement or enrich the CO₂ concentration of the air inside greenhouse 99. Although not shown, carbon dioxide 108 can also be used to enrich the air used to cultivate algae, or in any other comparable applications.

Greenhouse 99 can be heated from sources of thermal energy generated from the production of low, neutral and/or negative carbon intensity hydrogen from electrolysis. Waste heat 103-WH, 107-WH, and 109-WH generated from biomass power plant 10, electrolysis unit 11, and CO₂ compression unit 12, respectively, can be converted to thermal energy used for heating greenhouse 99. The sources of waste heat that can be used for thermal energy are discussed in more detail herein with respect to specific embodiments of the present invention.

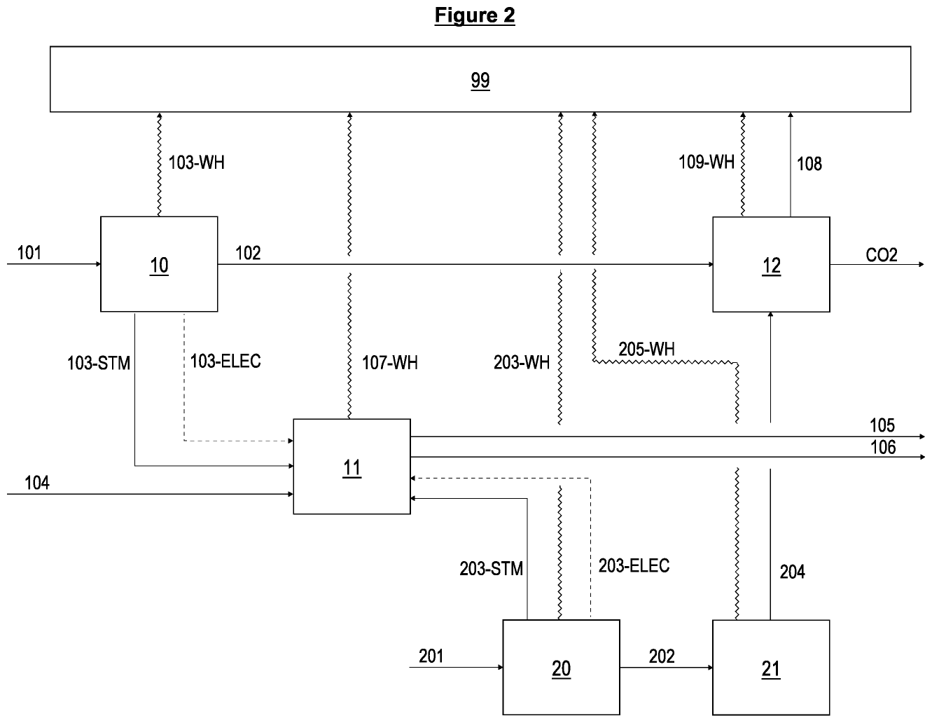

In a second embodiment of the present invention, FIG. 2 illustrates greenhouse 99 utilizing waste heat from the production of low, neutral, and/or negative carbon intensity hydrogen from electrolysis, wherein the required energy is provided by a biomass power plant with carbon capture and a gas turbine with carbon capture.

Similar to FIG. 1, water 104 is converted to a low, neutral, and/or negative carbon intensity hydrogen 105 and oxygen 106 in electrolysis unit 11 with carbon negative energy in the form of electricity, 103-ELEC, and/or steam, 103-STM, from biomass power plant 10.

Hydrocarbon fuel 201 is combusted in gas turbine 20, utilizing a Brayton cycle to generate low or neutral carbon intensity electricity 203-ELEC to provide power to electrolysis unit 11. Steam 203-STM can also be generated with a HRSG on the gas turbine exhaust. This steam can be used in a Rankine cycle to generate additional electricity 203-ELEC. Steam 203-STM can also be used as process steam for high-temperature steam electrolysis (HTSE) or as thermal energy in electrolysis unit 11.

Although not shown in FIG. 2, hydrocarbon fuel 201 can be blended with hydrogen 105 or can be wholly comprised of hydrogen 105 to reduce CO₂e emissions associated with energy, in the form of electricity, 203-ELEC, and/or steam, 203-STM, produced in gas turbine 20.

Carbon dioxide 204 can be separated and removed from turbine exhaust 202 in post-combustion capture (PCC) unit 21. Carbon dioxide 204 along with carbon dioxide 102 from biomass power plant 10 can be compressed in CO₂ compression unit 12 and sent to geologic sequestration or can be used external to the process. Carbon dioxide 108 can also be used to supplement or enrich the CO₂ concentration of the air inside greenhouse 99. Although not shown, carbon dioxide 108 can also be used to enrich the air used to cultivate algae, or in any other comparable applications.

Greenhouse 99 can be heated from sources of thermal energy generated from the production of low, neutral and/or negative carbon intensity hydrogen from electrolysis. In addition to the sources of waste heat from the first embodiment, outlined above, waste heat 203-WH and 205-WH generated from gas turbine 20 and PCC unit 21, respectively, can also be converted to thermal energy used for heating greenhouse 99.

In all embodiments described herein, gas turbine 20 can be configured as simple cycle, combined cycle, cogeneration, or a combination thereof.

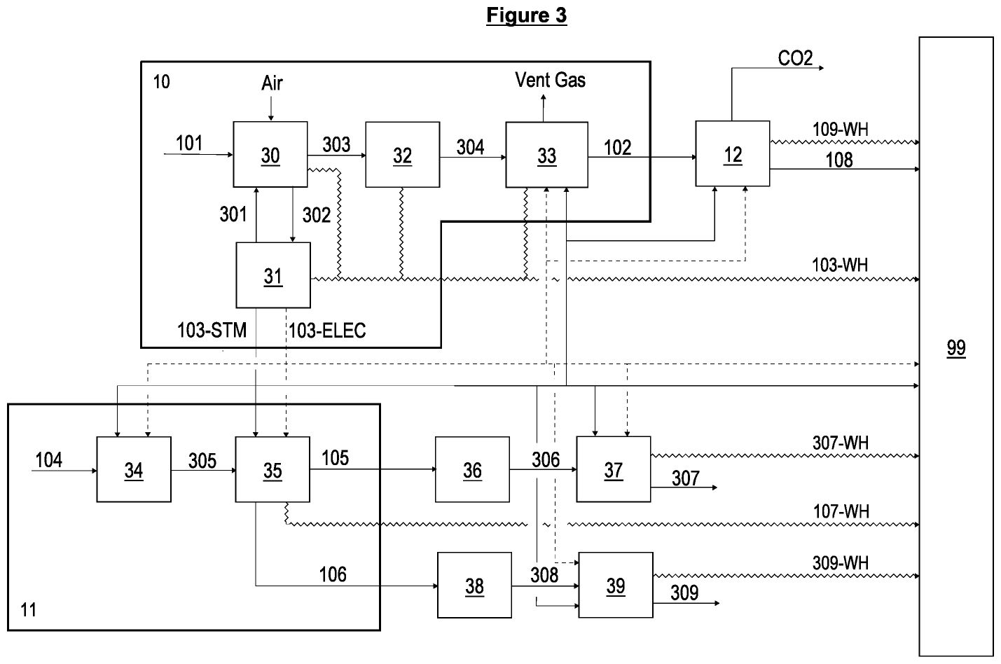

In a third embodiment of the present invention, FIG. 3 illustrates a more detailed version of FIG. 1 in which sources of waste heat from the production of low, neutral, and/or negative carbon intensity hydrogen produced by electrolysis are utilized by greenhouse 99.

Biomass power plant 10 is depicted as a Rankine cycle power plant, with carbon capture. Biomass feedstock 101 is combusted in boiler 30 to produce steam 302 that can be sent to steam turbine 31 to generate electricity 103-ELEC for greenhouse 99. Steam 103-STM can be extracted from steam turbine 31 to provide a source of thermal energy for greenhouse 99 heating requirements and/or power the mechanical drive for pumps, heat pumps, and/or fans. Not shown in FIG. 3, steam 302 can also be sent directly to greenhouse 99 for use as thermal energy and/or power the mechanical drives. Furthermore, electricity 103-ELEC and steam 103-STM can also be sent to electrolysis unit 11 and/or CO₂ compression unit 12.

Flue gas 303 from boiler 30 is sent through air quality control system 32, where it passes through several, optional emissions reduction technologies. The treated flue gas 304 is then sent to post combustion capture (PCC) unit 33 where carbon dioxide 102 is separated from the flue gas. Flue gas 303 and treated flue gas 304 can both be utilized as sources of thermal energy for waste heat 103-WH, which can be used for heating greenhouse 99.

Carbon dioxide 102 can be compressed in CO₂ compression unit 12 for geologic sequestration or can be used external to the process. Carbon dioxide 108 can be used to enrich the air inside greenhouse 99 to optimize and increase plant growth. Although not shown, carbon dioxide 108 can also be used to enrich the air used to cultivate algae, or in any other comparable applications.

The heat of compression in CO₂ compression unit 12 can be utilized as a source of thermal energy for waste heat 109-WH, which can be used for heating greenhouse 99.

Electrolysis unit 11 splits water into hydrogen and oxygen. Raw water 104 is sent to water treatment unit 34 to remove impurities, such as particulates, organic compounds, and/or mineral salts to produce treated or deionized water 305. Treated or deionized water 305 is sent to electrolyzer 35 to produce hydrogen and oxygen with carbon negative energy from biomass power plant 10. Waste heat 107-WH can be harnessed from the hydrogen and oxygen produced by electrolyzer 35 because it operates at elevated temperatures due to the amount of energy required for electrolysis to occur. Waste heat 107-WH can be utilized as a source of thermal energy for heating greenhouse 99.

Hydrogen produced in electrolyzer 35 can be sent to a water separator to remove water. Depending on the desired moisture content, the hydrogen can also be sent to a dryer system. Hydrogen 105 is sent to hydrogen storage 36 and can be an be compressed in hydrogen compression unit 37. The heat of compression in hydrogen compression unit 37 can be utilized as a source of thermal energy for waste heat 307-WH, which can be used for heating greenhouse 99.

Oxygen produced in electrolyzer 35 is sent to a water separator to remove water. Oxygen 106 is sent to oxygen storage 38 and can be compressed in oxygen compression unit 39. The heat of compression in oxygen compression unit 39 can be utilized as a source of thermal energy for waste heat 309-WH, which can be used for heating greenhouse 99.

The biomass power plant 10, electrolysis unit 11, and CO₂ compression unit 12 use cooling water and/or air-cooled heat exchangers to provide a means of cooling to the process. In these applications, the heat generated by the system is rejected to the atmosphere by evaporative cooling towers, air-cooled fans (e.g. dry cooling systems), or a combination thereof. Although not shown in FIG. 3, the cooling water return could be used as a source of thermal energy used for heating greenhouse 99.

Depending on the configuration, greenhouse 99 is heated by either central or local heating systems. Typically, central heating systems consist of a fired boiler that produces and distributes either hot water or steam throughout the greenhouse, whereas local heating systems transfer heat from the combustion of a fuel to the nearby surrounding air through forced-air heat exchangers or through the flue gas piping. Steam from biomass plant 10 can be used to provide central or local heating to greenhouse 99. Thermal energy from 103-WH, 107-WH, 109-WH, 307-WH, and/or 309-WH can also be utilized to provide heating to greenhouse 99.

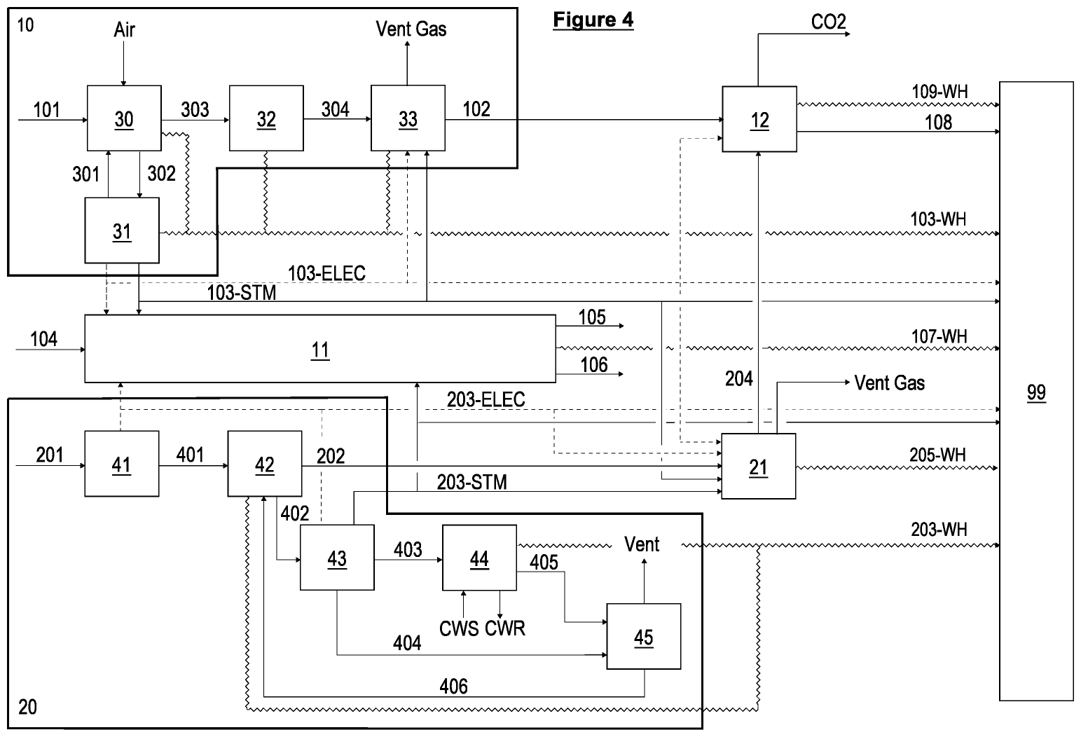

In a fourth embodiment of the present invention, FIG. 4 illustrates greenhouse 99 utilizing waste heat from the production of low, neutral, and/or negative carbon intensity hydrogen from electrolysis, wherein the required energy is provided by a biomass power plant with carbon capture and a combined cycle gas turbine with carbon capture.

Although not shown in FIG. 4, the carbon neutral or carbon negative electricity for greenhouse 99 can be produced from a combination of simple cycle, combined cycle, and/or cogeneration turbines.

Similar to FIG. 3, raw water 104 is converted to a low, neutral, and/or negative carbon intensity hydrogen 105 and oxygen 106 in electrolysis unit 11 with carbon negative energy in the form of electricity, 103-ELEC, and/or steam, 103-STM, from biomass power plant 10. FIG. 4 also illustrates gas turbine 20 providing low and/or neutral carbon intensity energy in the form of electricity, 203-ELEC, and/or steam, 203-STM to electrolysis unit 11 and/or greenhouse 99.

Hydrocarbon fuel 201 is sent to gas turbine 41 and is combusted to generate low and/or neutral carbon intensity electricity 203-ELEC in a Brayton cycle to power electrolysis unit 11 and/or greenhouse 99. Turbine exhaust 401 is sent to HRSG 42, and the cooled turbine exhaust 202 passes through optional emissions reduction technologies prior to being sent to PCC unit 21. Waste heat 203-WH can also be harnessed from turbine exhaust 401, which operates at elevated temperatures, and utilized as a source of thermal energy for heating greenhouse 99.

Waste heat 205-WH can be harnessed from multiple process streams within PCC unit 21 that operate at elevated temperatures which can be utilized as sources of thermal energy for heating greenhouse 99. Also, PCC unit 21 uses cooling water and/or air-cooled heat exchangers to provide a means of cooling to the process. The heat generated by the system is rejected to the atmosphere by evaporative cooling towers, air-cooled fans (e.g. dry cooling systems), or a combination thereof. Although not shown in FIG. 4, the waste heat in the cooling water return could also be used as a source of thermal energy used for heating greenhouse 99.

Although not shown, PCC unit 21 can optionally be combined with PCC unit 33 in biomass power plant 10.

Superheated steam 402 is produced in HRSG 42 from the waste heat from turbine exhaust 401. Superheated steam 402 is sent to steam turbine 43, in which additional low and/or neutral carbon intensity electricity 203-ELEC is produced by a Rankine cycle to power electrolysis unit 11 and/or greenhouse 99.

Although not shown, HRSG 42 can also be configured to be duct fired to produce additional superheated steam and thus generate additional electricity.

Steam 203-STM can be extracted from steam turbine 43 to provide thermal energy for heating greenhouse 99 and/or provide energy to power the mechanical drives for pumps, heat pumps, and/or fans. Steam 203-STM can also be used as a source of thermal energy for PCC unit 21.

Steam turbine exhaust 403 is condensed in surface condenser 44, and condensate 405 is sent to deaerator 45. Deaerator stripping steam 404 is extracted from steam turbine 43. Boiler feed water 406 from deaerator 45 is sent to HRSG 42 to produce superheated steam 402.

Surface condenser 44 uses cooling water and/or air-cooled heat exchangers to provide a means of cooling to the process. In this application, the heat generated by the system is rejected to the atmosphere by evaporative cooling towers, air-cooled fans (e.g. dry cooling systems), or a combination thereof. Although not shown in FIG. 4, the waste heat in the cooling water return could be used as a source of thermal energy used for heating greenhouse 99.

Carbon dioxide 204 can be separated and removed from turbine exhaust 202 in PCC unit 21. Carbon dioxide 204 along with carbon dioxide 102 from biomass power plant 10 can be compressed in CO₂ compression unit 12 and sent to geologic sequestration or can be used external to the process. Carbon dioxide 108 can be used to enrich the air inside greenhouse 99 to optimize and increase plant growth. Although not shown, carbon dioxide 108 can also be used to enrich the air used to cultivate algae, or in any other comparable applications.

Steam from biomass plant 10 and/or gas turbine 20 can be used to provide central or local heating to greenhouse 99. Thermal energy from 103-WH, 107-WH, 109-WH, 203-WH, and/or 205-WH can also be utilized to provide heating to greenhouse 99.

In yet another embodiment of the present invention, a method for providing energy from waste heat from an electrolysis process to one or more commercial or industrial operations is provided. The method includes the steps of converting water to oxygen and a hydrogen product through an electrolysis process, wherein the hydrogen product has a carbon intensity preferably less than about 0.45 kg CO₂e/kg H₂, more preferably less than 0.0 kg CO₂e/kg H₂. At least some of, and preferably substantially all of the required energy for the electrolysis process is provided from a biomass power plant, wherein the energy produced by the biomass power plant is selected from one or more of: (a) electricity generated from work produced by a Rankine cycle, Brayton cycle, or integrated gasification combine cycle; (b) steam that can be used as process steam in the hydrogen production process; (c) steam that can be used as thermal energy; or (d) steam that can be used to power a mechanical drive. One or more gas streams containing carbon dioxide from the biomass power plant may be processed in a carbon capture unit to reduce CO₂e emissions. The waste heat is recovered from the electrolysis process, and then at least some of the waste heat is converted to thermal energy for use in the one or more commercial or industrial operations. At least some of the thermal energy may be converted to steam to power a mechanical drive for one or more motors generating shaft torque in the one or more commercial or industrial operations. The thermal energy may also be used to produce hot water or steam for district heating in the one or more commercial or industrial operations. The thermal energy may also be used to produce hot water or steam for an absorption chiller to provide chilling duty for district cooling in the one or more commercial or industrial operations.

In yet another embodiment of the present invention, a method for providing thermal energy from waste heat from an electrolysis process to one or more greenhouses is provided, the thermal energy being used to heat the one or more greenhouses. The method also includes recovering carbon dioxide from the biomass power plant, wherein the recovered carbon dioxide is used to supplement the CO₂ concentration of the air inside the one or more greenhouses.

In yet another embodiment of the present invention, a method for providing thermal energy from waste heat from an electrolysis process to one or more algae farms is provided, the thermal energy being used to heat the one or more algae farms. The method also includes recovering carbon dioxide from the biomass power plant, wherein the recovered carbon dioxide is used to enrich the CO₂ concentration of the sparging air in the one or more algae farms.

In yet another embodiment of the present invention, a method for providing thermal energy from waste heat from an electrolysis process to district utilities comprising one or both of district cooling and district heating.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and spirit of the present invention.

What is claimed is:

1. A method for providing energy from waste heat to one or more commercial or industrial operations, comprising:
converting water to oxygen and a hydrogen product through an electrolysis process, wherein the hydrogen product has a carbon intensity less than about 0.45 kg CO₂e/kg H₂, wherein at least some of the required energy for the electrolysis process is provided from a biomass power plant;
processing one or more gas streams containing carbon dioxide from the biomass power plant in a carbon capture unit to reduce CO₂e emissions;
recovering waste heat from the electrolysis process; and
converting at least some of the waste heat to thermal energy for use in the one or more commercial or industrial operations.

2. The method of claim 1, wherein the energy produced by the biomass power plant is selected from one or more of:
(a) electricity generated from work produced by a Rankine cycle, Brayton cycle, or integrated gasification combine cycle;
(b) steam that can be used as process steam in the hydrogen production process;
(c) steam that can be used as thermal energy; or
(d) steam that can be used to power a mechanical drive; and

3. The method of claim 1, further comprising converting at least some of the thermal energy to steam to power a mechanical drive for one or more motors generating shaft torque in the one or more commercial or industrial operations.

4. The method of claim 1, wherein the thermal energy is used to produce hot water or steam for district heating in the one or more commercial or industrial operations.

5. The method of claim 1, wherein the thermal energy is used to produce hot water or steam for an absorption chiller to provide chilling duty for district cooling in the one or more commercial or industrial operations.

6. The method of claim 1, wherein the one or more commercial or industrial operations comprises one or more greenhouses, and the thermal energy is used to heat the one or more greenhouses.

7. The method of claim 6, further comprising recovering carbon dioxide from the biomass power plant, wherein the recovered carbon dioxide is used to supplement the CO₂ concentration of the air inside the one or more greenhouses.

8. The method of claim 1, wherein the one or more commercial or industrial operations comprises one or more algae farms, and the thermal energy is used to heat the one or more algae farms.

9. The method of claim 8, further comprising recovering carbon dioxide from the biomass power plant, wherein the recovered carbon dioxide is used to enrich the CO₂ concentration of the sparging air in the one or more algae farms.

10. The method of claim 1, wherein the one or more commercial or industrial operations comprises district utilities comprising one or both of district cooling and district heating.

11. The method of claim 1, wherein the hydrogen product has a carbon intensity less than about 0.0 kg CO₂e/kg H₂.

12. The method of claim 1, wherein substantially all of the required energy for the electrolysis process is provided from the biomass power plant.
